(19) United States
(12) Patent Application Publication
(10) Pub. No.: US 2016/0142374 A1
(43) Pub. Date: May 19, 2016

(54) PRIVATE AND SECURE COMMUNICATION SYSTEMS AND METHODS

(71) Applicant: D. Scott CLARK, Fort Lauderdale, FL (US)

(72) Inventor: D. Scott CLARK, Fort Lauderdale, FL (US)

(21) Appl. No.: 14/939,616

(22) Filed: Nov. 12, 2015

Related U.S. Application Data
(60) Provisional application No. 62/079,250, filed on Nov. 13, 2014.

(51) Int. Cl. H04L 29/06; H04L 12/46

(52) U.S. Cl. CPC H04L 63/0272; H04L 12/4641; H04L 12/4633; H04L 65/1006; H04L 63/029; H04L 63/06; H04L 63/08; H04L 63/166

(57) ABSTRACT

Private and secure communication systems and methods implemented by a server in a local network behind a local router/firewall include authenticating a client device based on a request from the client device, wherein the request is for a tunnel from the server to the client device through the local router/firewall for a communication session with another client device; configuring and establishing a Virtual Private Network (VPN) tunnel over the Internet with the client device; and establishing the communication session with the another client device utilizing Session Initiation Protocol (SIP) for both signaling and media, wherein the server operates both as a VPN server and a Private Branch Exchange (PBX) for communication sessions utilizing SIP, and wherein the communication session is logged at a local level of the server.

### CROSS-REFERENCE TO RELATED APPLICATION(S)

The present patent/application claims priority to U.S. Provisional Application No. 62/079,250 filed on Nov. 13, 2014, and entitled “PRIVATE AND SECURE COMMUNICATION SYSTEM VIA A REGISTERED PRIVATE BRANCH EXCHANGE NETWORK,” the contents of which are incorporated by reference.

### FIELD OF THE DISCLOSURE

The present disclosure relates to the field of communications with emphasis on privacy and security of a communication session; where a communication session is defined as a voice call, video call, and/or SMS (text) message from a registered, Registered Private Branch Exchange Network™ (RPBEN), mobile device (e.g., smartphone or tablet) to another RPBEN registered mobile device, or a RPBEN mobile device to a RPBEN landline device, anywhere in the world, toll-free.

### BACKGROUND OF THE DISCLOSURE

The proliferation of mobile devices to communicate private and sensitive communications across public and proprietary, non-secure networks mandates that individuals, companies, and organizations have the right to privacy of their communication. The lack of security and privacy in communication sessions has been well documented, including government eavesdropping, meta-data collection, and the like. Therefore, based on well-known and documented failures by telecommunication companies to secure the privacy of their subscribers' communications on proprietary GSM encrypted networks and other similar communication network infrastructures, a solution that establishes control of communication privacy and their meta-data with its users and organizations is needed.

### BRIEF SUMMARY OF THE DISCLOSURE

In various exemplary embodiments, systems and methods are described for establishing a secure communication session between two mobile devices, or a mobile device and landline using 3G/4G, Wi-Fi, or the like to act as the communication session carrier only. A communication session is established in the form of voice, video or SMS (text) communication signals. The secure communication session uses a virtual private network (VPN) installed on a local network device or a virtual server at the local area network (LAN) level, and a locally installed private branch exchange (PBX) configured on the same network device to establish, maintain and terminate a communication session. By first initiating a TUN adapter to establish a SIP connection which then calls for TLS and SRTP protocols, doubling the level of encryption for a given session. The technique calls for configuring the VPN server to use routing for the SIP session for both signaling and media, as opposed to NAT or SIP proxy. A communication session is logged at the local RPBEN level only. Any request from outside the owner of the system will have to be sent directly to the owner, thus increasing the transparency of such request and eliminates the reporting requirements for a host company to supply its customers with notice that records were requested.

In an exemplary embodiment, a private and secure communication method implemented by a server in a local network in or behind a local router/firewall includes authenticating a client device based on a request from the client device, wherein the request is for a tunnel from the server to the client device through the local router/firewall for a communication session with another client device; configuring and establishing a Virtual Private Network (VPN) tunnel over the Internet with the client device; and establishing the communication session with the another client device utilizing Session Initiation Protocol (SIP) for both signaling and media, wherein the server operates both as a VPN server and a Private Branch Exchange (PBX) for communication sessions utilizing SIP, and wherein the communication session is logged at a local level of the server. The method can further include causing installation of software comprising a Virtual Private Network (VPN) Tunnel client and softphone client of the client device, and creating a client profile for the software such that the client device is a registered client for the server. The authenticating can utilize a pluggable authentication module (PAM) thus requiring no external server from the server for the authenticating. The authenticating can utilize a 2048-bit static key and authentication using a signature using SHA-256 encryption. The VPN tunnel can utilize both Transport Layer Security protocol (TLS) and Secure Real-time Transport Protocol (SRTP) to double a level of encryption for the communication session, providing additional security and requiring both keys for decryption. The SIP can be utilized for both signaling and media without Network Address Translation (NAT) or a SIP proxy. The method can further include performing the communication session to forward traffic between the VPN tunnel for the client device and another VPN tunnel for the another client device. The server is not directly accessible over the Internet.

In another exemplary embodiment, a server adapted to perform private and secure communication includes a network interface communicatively coupled to the Internet through a local router/firewall device; a processor communicatively coupled to the network interface; and memory storing instructions that, when executed, cause the processor to authenticate a client device based on a request from the client device, wherein the request is for a tunnel from the server to the client device through the local router/firewall for a communication session with another client device; configure and establish a Virtual Private Network (VPN) tunnel over the Internet with the client device; and establish the communication session with the another client device utilizing Session Initiation Protocol (SIP) for both signaling and media, wherein the server operates both as a VPN server and a Private Branch Exchange (PBX) for communication sessions utilizing SIP, and wherein the communication session is logged at a local level of the server. The memory storing instructions that, when executed, can further cause the processor to cause installation of software comprising a Virtual Private Network (VPN) Tunnel client and softphone client of the client device; and create a client profile for the software such that the client device is a registered client for the server. The authenticating can utilize a pluggable authentication module (PAM) thus requiring no external server from the server for the authenticating. The authenticating can utilize a 2048-bit static key and authentication using a signature using SHA-256 encryption. The VPN tunnel can utilize both Transport Layer Security protocol (TLS) and Secure Real-time Transport Protocol (SRTP) to double a level of encryption for the communication session, providing additional security and requiring both keys for decryption. The SIP can be utilized for both signaling and media without Network Address Translation (NAT) or a SIP proxy. The memory storing instructions that, when executed, can further cause the processor to performing the communication session to forward traffic between the VPN tunnel for the client device and another VPN tunnel for the another client device. The server is not directly accessible over the Internet.

In another exemplary embodiment, an apparatus adapted to perform private and secure communication includes a network interface communicatively coupled to the Internet through a local router/firewall device; a processor communicatively coupled to the network interface configured to operate as a Virtual Private Network (VPN) tunnel server to authenticate a client device based on a request from the client device, wherein the request is for a tunnel from the server to the client device through the local router/firewall for a communication session with another client device, and to configure and establish a VPN tunnel over the Internet with the client device; and operate as a Private Branch Exchange (PBX) for communication sessions utilizing Session Initiation Protocol (SIP) for both signaling and media, wherein the communication session is logged at a local level of the apparatus. The VPN tunnel can utilize both Transport Layer Security protocol (TLS) and Secure Real-time Transport Protocol (SRTP) to double a level of encryption for the communication session, providing additional security and requiring both keys for decryption. The SIP can be utilized for both signaling and media without Network Address Translation (NAT) or a SIP proxy. The apparatus is not directly accessible over the Internet.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of an RPBEN network and various mobile device components;

FIG. 2 is a network diagram of the RPBEN network with various communication sessions therein;

FIG. 3 is a block diagram of an exemplary implementation of the RPBEN server in the RPBEN network of FIGS. 1 and 2;

FIG. 4 is a block diagram of a mobile device which can be used in the RPBEN network of FIGS. 1 and 2;

FIG. 5 is a flowchart of a VPN method for connecting client devices to the RPBEN server; and

FIG. 6 is a flowchart of a communication method for communicating between client devices via the RPBEN server.

### DETAILED DESCRIPTION OF THE DISCLOSURE

In various exemplary embodiments, the present disclosure relates to private and secure communication systems and methods. There remains an essential requirement to secure communications across disparate global communication networks. The present disclosure, Registered Private Branch Exchange Network (RPBEN), solves this dilemma. As described herein, the term Registered Private Branch Exchange Network (RPBEN) is meant to describe functionality such as a functional overlay network and various nodes or elements therein, and not a specific product or implementation. For example, the term RPBEN server could be any server performing functionality associated with the RPBEN, and likewise, an RPBEN mobile device or RPBEN landline is a corresponding device capable of communication over the RPBEN. That is, any mobile device or landline could be adapted to communicate over the RPBEN based on the description herein. The RPBEN is best established within organizations where privacy of communications between organizationally-administered mobile devices, located throughout the world, demand an enhanced level of privacy and security of their communications.

In various exemplary embodiments, the systems and methods detailed herein address the innate deficiencies of current global communications networks, as those deficiencies relate to secure and private communications. By building in a unique preset method, using an open-source architecture; in combination with well-established and secure communication protocols, which shift a communication session off of GSM networks and other public-facing networks to a private and secure LAN-based, Registered Private Branch Exchange Network™ (RPBEN).

The present disclosure describes a method of construction for assembling and terminating a private communication (e.g., voice, video and SMS) session between network-enabled devices (e.g., mobile device or landline device) registered on an RPBEN across disparate global communication networks, using the telecommunication provider only for the transport of the communication session. The Registered Private Branch Exchange Network (RPBEN) allows its registered devices to connect through a secure communication tunnel from a mobile device or other network-enabled device anywhere in the world where a 3G/4G, Wi-Fi communication connection or another network connection is available.

The present disclosure uses routing at the VPN level to establish a SIP connection for both signaling and media encryption. In doing so, RPBEN uses static entries at the client device (client device) in a precise search pattern: SIP→VPN. In an exemplary embodiment, a server device (network appliance) can be behind the firewall at the LAN level using port forwarding on UDP port 1194 only for RPBEN connectivity. The present disclosure accommodates both RPBEN/VPN server and RPBEN/PBX server to coexist on a single network appliance. Also, a precise configuration of Transport Layer Security protocol (TLS) and Secure Real-time Transport Protocol (SRTP) doubles the level of encryption for a given communication session, providing additional security.

The systems and methods for the RPBEN are not a standalone application, nor a cloud-based solution (i.e., Software as a Service), nor a secure mobile device by itself Rather, the systems and methods are a mobile device-independent, the end-to-end private network providing organizations, individuals, etc. the capability of a global, private communications network for voice, text, and/or video. Importantly, the systems and methods take an end-to-end approach to ensure the utmost security and privacy at all points. The end-to-end private network can be realized via hardware appliances and/or virtual servers.

In various exemplary embodiments, the following terminology is utilized:

| | | |
|---|---|---|
| 1 | Auto-login profile | Device profile generated for initial setup of a |
| | | registered mobile device on RPBEN |
| 2 | Certificates | SSL certificate |
| 3 | Channels | Transmission medium |
| 4 | Client | A registered user on RPBEN or End-user |
| 5 | Client mobile device | Registered mobile device such as a smartphone or tablet |
| 6 | Client profile | Configuration of client's auto-login profile, VPN and |
| | | softphone settings |
| 7 | Client-side computer | Computer residing with the end-users |
| 8 | Communication gateway | Device that directs communication traffic on the |
| | | Internet |
| 9 | GMS, CDMA | Global System for Mobile Communications |
| | | Code Division Multiple Access |
| 10 | IP | Internet Protocol |
| 11 | IP Gateway | Local installed router |
| 12 | Media | Contents of a communication session |
| 13 | NAT | Network Address Translation which is a |
| | | communication protocol with 1:1 translation |
| 14 | Network appliance | A specialized device for use on a network. |
| 15 | Network-enabled device | Smartphone or tablet device with access to |
| | | communication network |
| 16 | PAM | A pluggable authentication module (PAM) is a |
| | | mechanism to integrate multiple low-level |
| | | authentication schemes into a high-level application |
| | | programming |
| 17 | PBX | Private Branch Exchange - a telephone exchange or |
| | | switching system that serves a private organization |
| | | and performs concentration of central office lines or |
| | | trunks and provides intercommunication between a |
| | | large number of telephone stations in the organization |
| 18 | PSTN | Public Switched Telephone Network |
| 19 | Registered | Authenticated on RPBEN |
| 20 | Registered device | Authenticated client device |
| 21 | RPBEN | Registered Private Branch Exchange Network |
| 22 | RPBEN/PBX | A component of RPBEN Server |
| 23 | RPBEN/VPN Server | A component of RPBEN Server |
| 24 | RPBEN Server | Refers to RPBEN and all components |
| 25 | RSA | Public-key cryptosystems and is widely used for |
| | | secure data transmission |
| 26 | Session | A communication event (voice, video, SMS) between |
| | | two devices |
| 27 | SHA-256 | Secure Hash Algorithm |
| 28 | SIP | Session Initiation Protocol (SIP) is a signaling |
| | | communications protocol, widely used for controlling |
| | | multimedia communication sessions such as voice and |
| | | video calls over Internet Protocol (IP) networks. |
| 29 | SMS | Simple Message Service |
| 30 | Softphone | A softphone is a software program for making |
| | | telephone calls over the Internet using a general |
| | | purpose computer, rather than using dedicated |
| | | hardware. |
| 31 | SSL | Secure Sockets Layer |
| 32 | TCP | Transmission Control Protocol |
| 33 | TUN adapter | TUN and TAP are virtual network kernel devices |
| | | supported entirely in software. TUN (namely network |
| | | TUNnel) simulates a network layer device, and it |
| | | operates with layer 3 packets like IP packets. TAP |
| | | (namely network tap) simulates a link layer device, |
| | | and it operates with layer 2 packets like Ethernet |
| | | frames. TUN is used with routing while TAP is used |
| | | for creating a network bridge. |
| 34 | UDP | User Datagram Protocol |
| 35 | Wi-Fi or WLAN | Wireless Fidelity, Wireless Local Area Network, etc. |
| | | such as conforming to the IEEE 802.11 family of |
| | | protocols. |
| 36 | XMPP | Extensible Messaging and Presence Protocol (XMPP) |
| | | is a communications protocol for message-oriented |
| | | middleware based on XML (Extensible Markup |
| | | Language). |

### §1.0 Network Diagram—Registration Process and Client Mobile Device Components

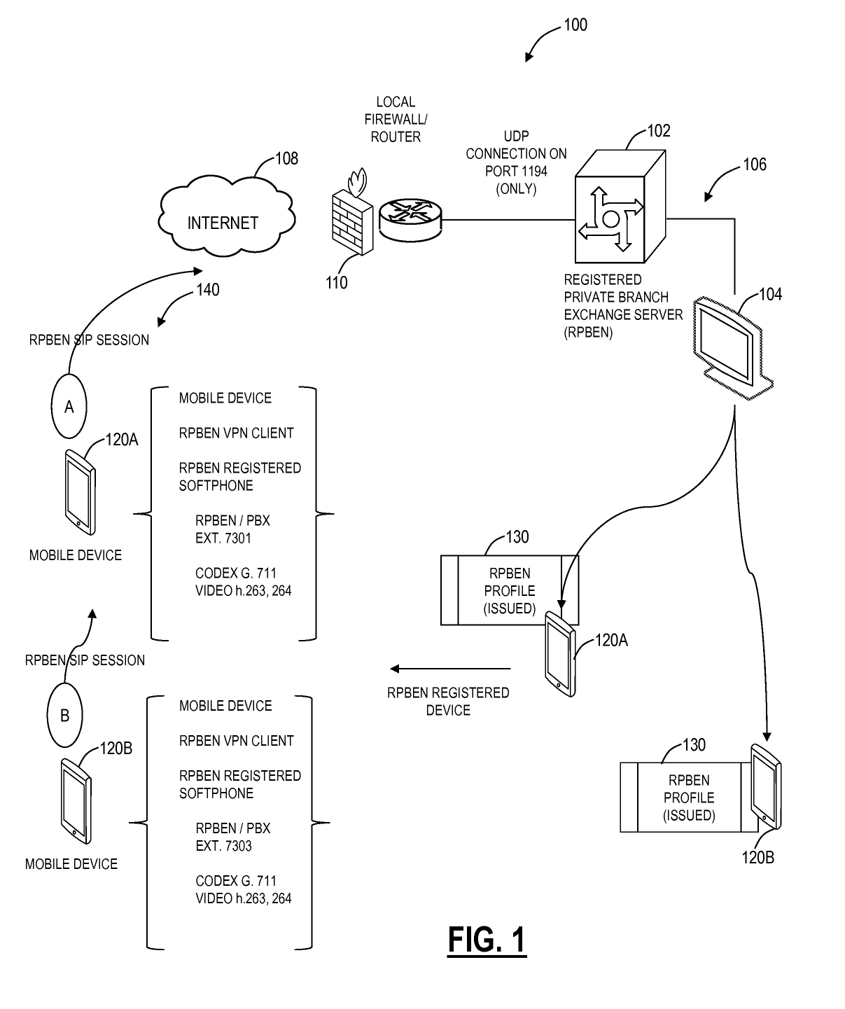

Referring to FIG. 1, in an exemplary embodiment, a network diagram illustrates an RPBEN network 100 and various mobile device components. The RPBEN network 100 includes, for example, an RPBEN server 102 and a client device configurator 104 in a local network 106. The local network 106 can connect to the Internet 108 via a local firewall/router 110. Various mobile devices 120A, 120B are configured to work with the RPBEN server 102 in the RPBEN network 100. The mobile devices 120A, 120B can be connected to the local network 106 or the Internet 108.

The RPBEN server 102 can be deployed in any local network 106 as a stand-alone, secure VPN tunnel server and PBX. In particular, the systems and methods contemplate the RPBEN server 102 as an open-source device, network appliance, virtual server, etc. that is fully hosted by the local network 106. In this sense, the RPBEN server 102 is fully under the physical control of an operator of the local network 106. This is more secure than a service offering where there is no physical control. That is, in an exemplary embodiment, the RPBEN network 100 is not a service, but a network infrastructure on top of the Internet 108 and the local network 106 providing robust security, both on the Internet 108 and physically in the local network 106. This is in contrast to other offerings which are service-based; these do not provide physical security in terms of who controls the end server. In various exemplary embodiments, the RPBEN server 102 can be easily and quickly deployed within the local network 106 to provide PBX services with the most robust security possible.

For registration, the RPBEN server 102 is configured to issue an auto-login profile and certificates to create a client profile 130, which is installed on a network enable device, e.g., the mobile devices 120. In an exemplary embodiment, the registration process is performed with the mobile device 120 directly connected to the RPBEN server 102, such as via a USB connection, etc. In another exemplary embodiment, the registration process is performed Over-the-Air (OTA) via (secure) wireless connections. Once the client profile is installed, the mobile device 120 is a registered client on the RPBEN network 100. The client configurator 104 is meant to program the mobile devices 120 for secure operation on the RPBEN network 100. In an exemplary embodiment, this programming could be with the mobile devices 120 physically present on the local network 106, such that no data associated with the registration process is open on the Internet 108.

The mobile device 120 includes an RPBEN VPN client, and an RPBEN registered softphone which can include a PBX configuration and a codex G.711 and video h.263, 264. Other codecs can be used, such as GSM, G711u, G729 for audio, VP8 for video. These are software components executed on the mobile device 120 for operation in the RPBEN network 100. These software components, in combination with the RPBEN profile 130 enable the mobile device 120 to provide secure communications over the RPBEN network 100, via SIP sessions 140. The RPBEN VPN client enabled connectivity between the mobile device 120 and the local network 106 over the Internet 108 and through the local firewall/router 110. The RPBEN registered softphone is an app enabling the user to engage in communication sessions in the RPBEN network 100. Note, the functionality of the RPBEN VPN client, the codex G.711, video h.263, 264, etc. can be integrated into a single app with the RPBEN registered softphone. Alternatively, the RPBEN VPN client can be integrated within an operating system of the mobile device 120. Of course, other embodiments are also contemplated.

### §2.0 Network Diagram—RPBEN Network Operation

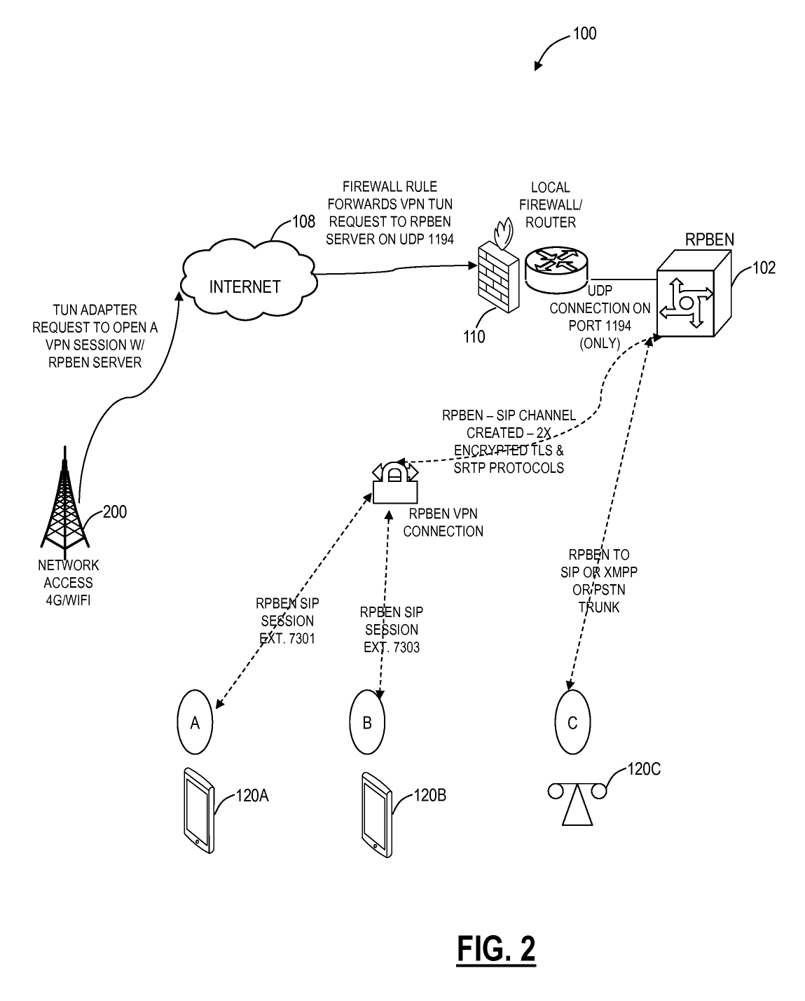

Referring to FIG. 2, in an exemplary embodiment, a network diagram illustrates the RPBEN network 100 with various communication sessions. In FIG. 2, the RPBEN network 100 includes the mobile devices 120A, 120B as well as a landline 120C. The landline 120C can be a network-enabled device such as a Voice over IP (VOIP) phone or the like. The mobile devices 120A, 120B can communicate with the RPBEN server 102 via a wireless network 200 and the Internet 108. The landline 120C can communicate to the RPBEN server 102 over the local network 106 or some other network over the Internet 108.

The RPBEN server 102 can provide two functions in the RPBEN network 100, namely a VPN server and a PBX, in the same device. The mobile devices 120A, 120B are configured to appear as a private extension. At the VPN layer, the RPBEN server 102 can establish SIP connections for both signaling and media of an encrypted communication session. The RPBEN server 102 is a gateway device behind the local firewall/router 110 to be established at the Local Area Network (LAN) level of the local network 106 by using port forwarding only on UDP port 1194. The Internet 108, wireless network 200, etc. can be used solely for transport only, with switching and connections via the RPBEN server 102, which is securely located within the local network 106, off the Internet 108. The RPBEN server 102 can be a server, virtual server, network appliance, etc. that acts as both a VPN access server and PBX. In an exemplary embodiment, the wireless network 200 can include a satellite network as well.

The mobile devices 120A, 120B can initiate a communication session with the RPBEN server 102 by establishing a VPN TUN interface dialling the number of another registered device on the RPBEN/PBX using installed softphone application. The VPN TUN interface is a software-based network device executed on the mobile device 120. The mobile device 120 communicates with the RPBEN server 102 on UDP port 1194 only and is authenticated using PAM, thus requiring no external server for the authentication. The UDP port 1194 is for OpenVPN, which is a newer, secure form of VPN using open source technology. OpenVPN uses the OpenSSL encryption library and SSLv3/TLSv1 protocols. The PAM authentication integrates multiple low-level authentication schemes into a high-level application programming interface (API). It allows programs that rely on authentication to be written independently of the underlying authentication scheme.

The mobile device 120 requests to open a communication session using the VPN TUN adapter to connect to the RPBEN server 102 via a VPN using UDP port 1194 forwarded to the local IP address of the RPBEN server 102, where the requested is authenticated. Note, the RPBEN server 102 has a VPN session to the mobile device 120. The mobile device 120 can use a 2048-bit static key and can authenticate with RSA Signature using an SHA-256 encryption algorithm to connect to the RPBEN server 102. Once authenticated, the mobile device 120 is allowed to request additional network services running on the RPBEN server 102. The mobile device 120 now has access RPBEN server 102 operating as a PBX through the RPBEN tunnel (TUN) IP address.

Again, once authenticated, the mobile device 102 has access to other RPBEN registered devices using routing and by doing so, a SIP connection is allowed to happen without using NAT Traversal. The RPBEN server 102 can function, in addition to a VPN server, as a PBX. The mobile device 102 uses VPN and static entries at the client in a precise search pattern: SIP→VPN.

As a PBX, the RPBEN server 102 can be configured for SIP with internal addresses. The RPBEN/PBX only initiates calls from a client device with an internal address. Since the RPBEN/VPN Server and the RPBEN/PBX reside on the same device, i.e., the RPBEN server 102, the VPN tunnel interface is considered internal and answers the SIP requests on its TUN interfaces created on the mobile device 102.

An IP Gateway for the local network 106 does not forward SIP traffic thus the communication session is unavailable to the Internet 108. Apart from using Extensible Messaging and Presence Protocol (XMPP) client or the PSTN using traditional analog and digital trunks.

The mobile device 120 can have a SIP client that is registered to its RPBEN/VPN gateway address; because the VPN gateway is also running the PBX services, i.e. the RPBEN server 102, NAT traversal or SIP proxy is not required. The devices 120A, 120B, 120C, can use SIP channels to make calls to other client devices using local SIP or analog phones co-located within the RPBEN/PBX network 100, or outbound via traditional telephony trunks. Voice connections can be set up using normal SIP channels utilizing a g.711 conventional audio codec. Video connections can be made using the same channels but also using video codecs h.263 or h.264.

The RPBEN/VPN server 102 allows client-to-client connections and its local firewall/router 110 is setup to forward traffic from one tunnel to another on the RPBEN server 102, allowing two remote client devices to communicate privately.

For added security, even from within the local network 106 and outside on the Internet 108, TLS and SRTP protocols are employed so that session detail records and media cannot be intercepted without access to both of encryption keys. Specifically, the communication sessions between the mobile device 120 and the RPBEN server 102 can use both the TLS and SRTP protocols separately. This is double the level of encryption for a communication session, i.e., eavesdropping requires access to both encryption keys.

The softphone application is audio, video and SMS capable with all of the audio and video codecs to match the (RPBEN) PBX.

The RPBEN registered VPN clients (the mobile devices 120) have auto-login profiles loaded so that the client registered device does not have to authenticate for each communication session, in so far as the user has employed a strong device passphrase.

When an RPBEN communication session is terminated, the session log is stored locally on the RPBEN/PBX server 102. Any requests from outside the owner of the system will have to be sent directly to the owner, thus increasing the transparency of such request and eliminates the reporting requirements for a hosting company to supply its customers with notice that records were requested.

Ho, et al., U.S. Pat. No. 7,583,662 issued Jun. 24, 2014, provides for a Voice Virtual Private Network using H323 protocol, whereas the present disclosure uses the more secure Session Initiated Protocol (SIP) to establish and maintain the communication session. Additionally, Ho, et al., deploys its communication gateway on a public network (i.e. Internet); whereas the present disclosure deploys the communication gateway on a Local Area Network (LAN), and provides for an additional level of user control and privacy of a communication session beyond what is claimed in Ho, et al. Furthermore, Ho, et al., requires two separate network devices to establish and maintain a communication session, one of which is directly accessible on the Internet, whereas the present disclosure requires a single network appliance installed at the LAN level to establish and maintain the secure communication session.

Key aspects of the present disclosure include:

The RPBEN server 102 is located behind a local firewall/router 110 in a private network, i.e., the local network 106, not directly accessible to the Internet 108 and secure tunnels are created from the RPBEN server 102 to external devices, thereby providing improved security over conventional systems and methods which are directly accessible on the Internet 108.

Secure communications are presented using existing protocols and infrastructure (i.e., the Internet 108) along with the RPBEN server 102 and softphone clients on the devices 120. As such, the present disclosure contemplates secure communications without requiring an overlaid infrastructure or changes to existing infrastructure.

### §3.0 Exemplary Server Architecture

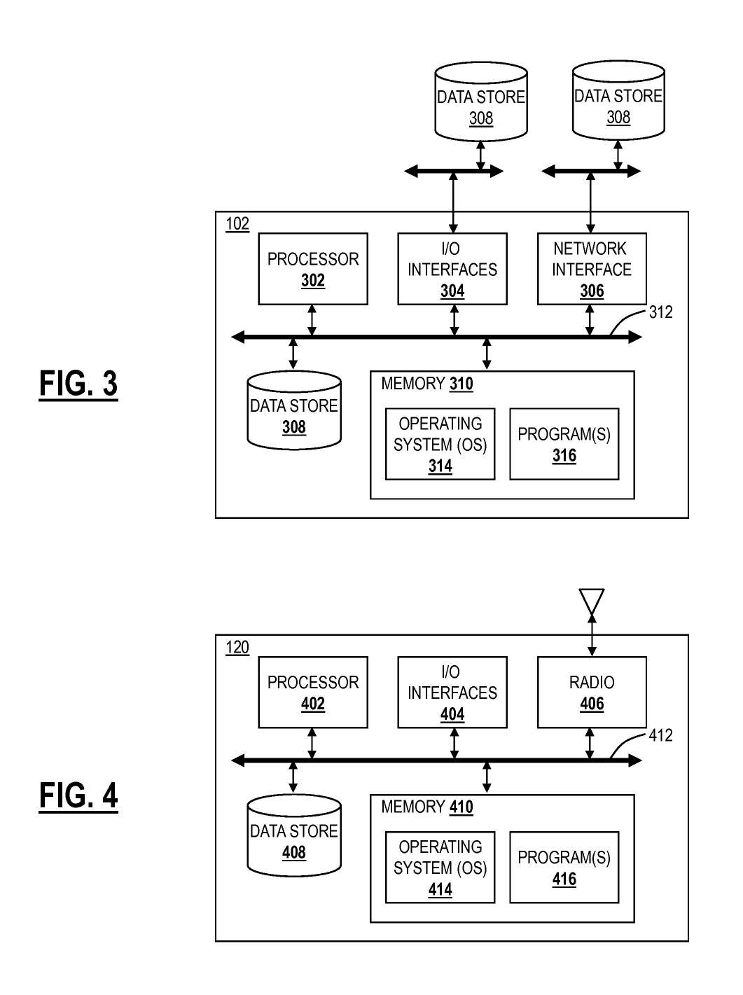

Referring to FIG. 3, in an exemplary embodiment, a block diagram illustrates an exemplary implementation of the RPBEN server 102. Further, the client device configurator 104, landline 120C, etc. may include the server 102 or similar structure. The server 102 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the server 102 in an oversimplified manner, and practical embodiment may include additional components and suitably configured processing logic to support known or conventional operating features that are not described in detail herein. The components (302, 304, 306, 308, and 310) are communicatively coupled via a local interface 312. The local interface 312 may be, for example, but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 102, a semiconductor-based microprocessor (in the form of a microchip or chip set), or generally any device for executing software instructions. When the server 102 is in operation, the processor 302 is configured to execute software stored within the memory 310, to communicate data to and from the memory 310, and to generally control operations of the server 102 pursuant to the software instructions. The I/O interfaces 304 may be used to receive user input from and/or for providing system output to one or more devices or components. User input may be provided via, for example, a keyboard, touchpad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 102 to communicate over a network, such as the Internet 108, the local network 106. The network interface 306 may include, for example, an Ethernet card or adapter (e.g., 10 BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 1208 may be located internal to the server 102 such as, for example, an internal hard drive connected to the local interface 312 in the server 102. Additionally in another embodiment, the data store 308 may be located external to the server 102 such as, for example, an external hard drive connected to the I/O interfaces 304 (e.g., SCSI or USB connection). In a further embodiment, the data store 308 may be connected to the server 102 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

### §4.0 Exemplary Mobile Device Architecture

Referring to FIG. 4, in an exemplary embodiment, a block diagram illustrates a mobile device 120 which can be used in the RPBEN network 100. The mobile device 120 can be a digital device that, in terms of hardware architecture, generally includes a processor 402, input/output (I/O) interfaces 404, a radio 406, a data store 408, and memory 410. It should be appreciated by those of ordinary skill in the art that FIG. 4 depicts the mobile device 120 in an oversimplified manner, and practical embodiment may include additional components and suitably configured processing logic to support known or conventional operating features that are not described in detail herein. The components (402, 404, 406, 408, and 402) are communicatively coupled via a local interface 412. The local interface 412 can be, for example, but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 120, a semiconductor-based microprocessor (in the form of a microchip or chip set), or generally any device for executing software instructions. When the mobile device 120 is in operation, the processor 402 is configured to execute software stored within the memory 410, to communicate data to and from the memory 410, and to generally control operations of the mobile device 120 pursuant to the software instructions. In an exemplary embodiment, the processor 402 may include an optimized mobile processor such as optimized for power consumption and mobile applications. The I/O interfaces 404 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 120. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 4, the software in the memory 410 includes a suitable operating system (O/S) 414 and programs 416. The operating system 414 essentially controls the execution of other computer programs and provides scheduling, input-output control, file and data management, memory management, and communication control and related services. The programs 416 may include various applications, add-ons, etc. configured to provide end user functionality with the mobile device 120. For example, exemplary programs 416 may include, but not limited to, a web browser, social networking applications, streaming media applications, games, mapping and location applications, electronic mail applications, financial applications, and the like.

### §5.0 Tunnel Methods

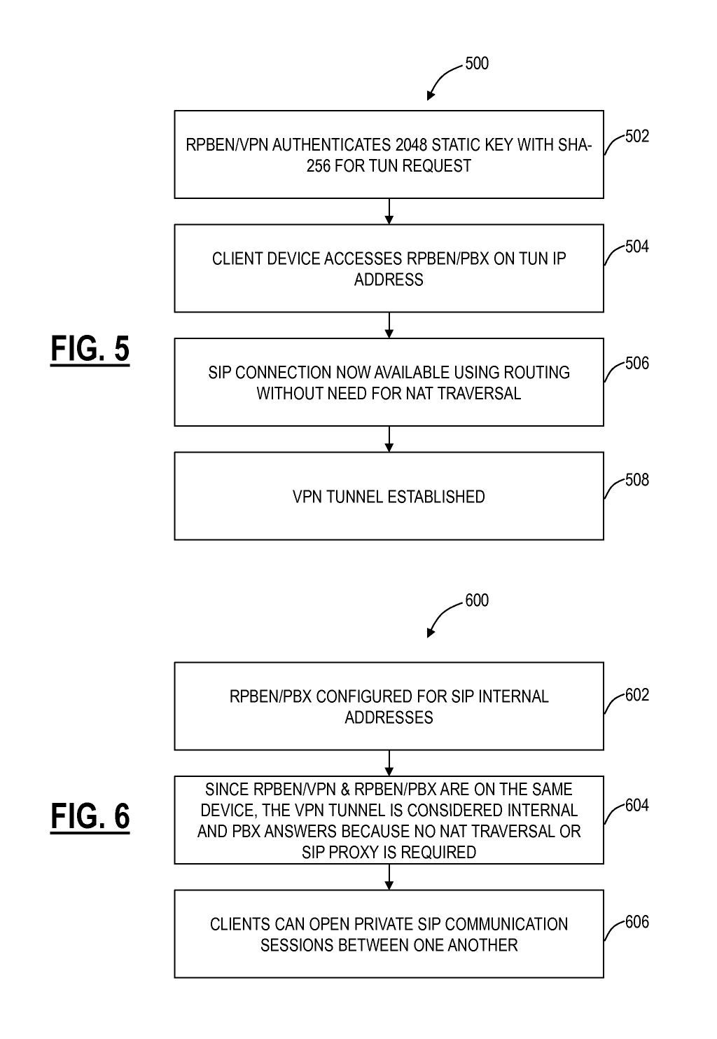

Referring to FIG. 5, in an exemplary embodiment, a flowchart illustrates a VPN method 600 for connecting client devices to the RPBEN server 102. The RPBEN server 102 acts as a VPN server authenticating a 2048 static key with SHA-256 for a TUN request, responsive to a request from the client device (step 502). The client device accesses the RPBEN server 102, acting as a PBX, on the TUN IP address (step 504). A SIP connection is now available to the client device using routing with a need for NAT traversal (step 506), and a VPN tunnel is established (step 508).

Referring to FIG. 6, in an exemplary embodiment, a flowchart illustrates a communication method 600 for communicating between client devices via the RPBEN server 102. The communication method 600 includes the RPBEN server 102, acting as a PBX, configured for SIP internal address (step 602). Since the RPBEN/VPN and the RPBEN/PBX are on the same device, the VPN tunnel is considered internal and the PBX answers because no NAT traversal of SIP proxy is required (step 604). The client devices can open private SIP communication sessions between one another (step 606).

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, the software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A private and secure communication method implemented by a server in a local network in or behind a local router/firewall, the method comprising:
authenticating a client device based on a request from the client device, wherein the request is for a tunnel from the server to the client device through the local router/firewall for a communication session with another client device;
configuring and establishing a Virtual Private Network (VPN) tunnel over the Internet with the client device; and
establishing the communication session with the another client device utilizing Session Initiation Protocol (SIP) for both signaling and media, wherein the server operates both as a VPN server and a Private Branch Exchange (PBX) for communication sessions utilizing SIP, and wherein the communication session is logged at a local level of the server.

2. The method of claim 1, further comprising:
causing installation of software comprising a Virtual Private Network (VPN) Tunnel client and softphone client of the client device; and
creating a client profile for the software such that the client device is a registered client for the server.

3. The method of claim 1, wherein the authenticating utilizes a pluggable authentication module (PAM) thus requiring no external server from the server for the authenticating.

4. The method of claim 1, wherein the authenticating utilizes a 2048-bit static key and authentication using a signature using SHA-256 encryption.

5. The method of claim 1, wherein the VPN tunnel utilizes both Transport Layer Security protocol (TLS) and Secure Real-time Transport Protocol (SRTP) to double a level of encryption for the communication session, providing additional security and requiring both keys for decryption.

6. The method of claim 1, wherein the SIP is utilized for both signaling and media without Network Address Translation (NAT) or a SIP proxy.

7. The method of claim 1, further comprising:
performing the communication session to forward traffic between the VPN tunnel for the client device and another VPN tunnel for the another client device.

8. The method of claim 1, wherein the server is not directly accessible over the Internet.

9. A server adapted to perform private and secure communication, the server comprising:
a network interface communicatively coupled to the Internet through a local router/firewall device;
a processor communicatively coupled to the network interface; and
memory storing instructions that, when executed, cause the processor to
authenticate a client device based on a request from the client device, wherein the request is for a tunnel from the server to the client device through the local router/firewall for a communication session with another client device;
configure and establish a Virtual Private Network (VPN) tunnel over the Internet with the client device; and
establish the communication session with the another client device utilizing Session Initiation Protocol (SIP) for both signaling and media, wherein the server operates both as a VPN server and a Private Branch Exchange (PBX) for communication sessions utilizing SIP, and wherein the communication session is logged at a local level of the server.

10. The server of claim 9, wherein the memory storing instructions that, when executed, further cause the processor to
cause installation of software comprising a Virtual Private Network (VPN) Tunnel client and softphone client of the client device; and
create a client profile for the software such that the client device is a registered client for the server.

11. The server of claim 9, wherein the authenticating utilizes a pluggable authentication module (PAM) thus requiring no external server from the server for the authenticating.

12. The server of claim 9, wherein the authenticating utilizes a 2048-bit static key and authentication using a signature using SHA-256 encryption.

13. The server of claim 9, wherein the VPN tunnel utilizes both Transport Layer Security protocol (TLS) and Secure Real-time Transport Protocol (SRTP) to double a level of encryption for the communication session, providing additional security and requiring both keys for decryption.

14. The server of claim 9, wherein the SIP is utilized for both signaling and media without Network Address Translation (NAT) or a SIP proxy.

15. The server of claim 9, wherein the memory storing instructions that, when executed, further cause the processor to
performing the communication session to forward traffic between the VPN tunnel for the client device and another VPN tunnel for the another client device.

16. The server of claim 9, wherein the server is not directly accessible over the Internet.

17. An apparatus adapted to perform private and secure communication, the apparatus comprising:
a network interface communicatively coupled to the Internet through a local router/firewall device;
a processor communicatively coupled to the network interface configured to
operate as a Virtual Private Network (VPN) tunnel server to authenticate a client device based on a request from the client device, wherein the request is for a tunnel from the server to the client device through the local router/firewall for a communication session with another client device, and to configure and establish a VPN tunnel over the Internet with the client device; and
operate as a Private Branch Exchange (PBX) for communication sessions utilizing Session Initiation Protocol (SIP) for both signaling and media, wherein the communication session is logged at a local level of the apparatus.

18. The apparatus of claim 17, wherein the VPN tunnel utilizes both Transport Layer Security protocol (TLS) and Secure Real-time Transport Protocol (SRTP) to double a level of encryption for the communication session, providing additional security and requiring both keys for decryption.

19. The apparatus of claim 17, wherein the SIP is utilized for both signaling and media without Network Address Translation (NAT) or a SIP proxy.

20. The apparatus of claim 17, wherein the apparatus is not directly accessible over the Internet.
